(19) United States
(12) Patent Application Publication
(10) Pub. No.: US 2026/0164359 A1
(43) Pub. Date: Jun. 11, 2026

(54) COMMUNICATION APPARATUS, CONTROL METHOD, AND STORAGE MEDIUM

(71) Applicant: CANON KABUSHIKI KAISHA, Tokyo (JP)

(72) Inventor: Yuki YOSHIKAWA, Kanagawa (JP)

(21) Appl. No.: 19/406,665

(22) Filed: Dec. 2, 2025

(30) Foreign Application Priority Data
Dec. 6, 2024 (JP) 2024-213382

(51) Int. Cl. H04W 52/02; H04W 76/15

(52) U.S. Cl. CPC H04W 52/0248; H04W 76/15

(57) ABSTRACT

A communication apparatus includes at least one memory storing a set of instructions, and at least one processor that, upon execution of the stored instructions, is configured to operate as a reception unit configured to receive information about a first wake period for communicating with a first partner communication apparatus by using a first communication method from the first partner communication apparatus, and a determination unit configured to determine a second wake period for communicating with a second partner communication apparatus by using a second communication method based on the first wake period.

### BACKGROUND

### Field of the Technology

The present disclosure relates to a communication apparatus, a control method, and a storage medium.

### Description of the Related Art

As data transmission volumes have increased in recent years, communication technologies, such as a wireless local area network (wireless LAN), are being developed. The Institute of Electrical and Electronics Engineers (IEEE) 802.11 family of standards is a known major wireless LAN communication standard. The IEEE 802.11 family of standards includes IEEE 802.11a/b/g/n/ac/ax and the like. For example, IEEE 802.11ax, which is the latest standard, standardizes a technology that realizes improved communication speed in addition to a high peak throughput of up to 9.6 gigabits per second (Gbps) using Orthogonal Frequency-Division Multiple Access (OFDMA).

Meanwhile, Wi-Fi® Alliance, which formulates authentication programs for wireless LAN devices, has formulated a Wi-Fi Direct® (WFD) standard defining a procedure for establishing a communication link between stations (STAs) of a wireless LAN by exchanging a communication parameter between the STAs without using an access point (AP). AP is short for access point, STA is short for station, and WFD is short for Wi-Fi Direct®. The STAs may also be referred to as non-AP STAs.

A Wi-Fi Aware standard, which is a standard for discovering a service provided by an apparatus, is also formulated. Japanese Patent Laid-Open No. 2019-201427 describes a technology that detects a communication apparatus using a Wi-Fi Aware standard.

Target Wake Time (TWT) is introduced in IEEE 802.11ah and subsequent standards to achieve both power saving and low-latency communication. The introduction of TWT enables communication during a period that is predetermined between an AP and a STA. Other periods are designated as periods during which no transmission or reception (e.g., communication) is performed, thereby enabling communication apparatuses to realize power saving. Hereinafter, the period that is predetermined will be referred to as a TWT Service Period (TWT SP). The TWT SP may also be referred to as a wake period (or a wake duration), an awake state period, an active state period, or the like.

A STA can communicate with another STA via WFD while maintaining infrastructure communication (e.g., communication in an infrastructure mode) in which the STA connects to and communicates with an AP, and this function enables simultaneous communication with two communication apparatuses. Hereinafter, performing infrastructure communication and WFD communication simultaneously will be referred to as simultaneous operation.

In a case where TWT SPs are set independently and individually for infrastructure communication and WFD communication during the simultaneous operation, the overall power efficiency of the communication apparatus may decrease, or a period during which the communication apparatus cannot operate as a communication apparatus may be set. Consequently, the communication apparatus may fail to properly perform at least one of the infrastructure communication and the WFD communication, which use different communication methods.

### SUMMARY

The present disclosure is directed to providing a technology for properly performing communications that use different communication methods and may be performed simultaneously.

According to an aspect of the present disclosure, a communication apparatus includes at least one memory storing a set of instructions, and at least one processor that, upon execution of the stored instructions, is configured to operate as a reception unit configured to receive information about a first wake period for communicating with a first partner communication apparatus by using a first communication method from the first partner communication apparatus, and a determination unit configured to determine a second wake period for communicating with a second partner communication apparatus by using a second communication method based on the first wake period.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating an example of a configuration of a wireless communication system according to an embodiment.

FIG. 2 is a diagram illustrating an example of a hardware configuration of a communication apparatus according to an embodiment.

FIG. 3 is a diagram illustrating an example of a functional configuration of a communication apparatus according to an embodiment.

FIG. 4 is a flowchart illustrating an example of a flow of a process performed by a communication apparatus according to a first example.

FIG. 5 is a flowchart illustrating an example of a flow of a process performed by a communication apparatus according to a second example.

FIGS. 6A and 6B are flowcharts illustrating an example of a flow of a process performed by a communication apparatus according to a third example.

FIG. 7 is a diagram illustrating an example of a processing sequence of communication apparatuses according to the first example.

FIG. 8 is a diagram illustrating an example of a processing sequence of communication apparatuses according to the first example.

FIG. 9 is a diagram illustrating an example of a processing sequence of communication apparatuses according to the second example.

FIG. 10 is a diagram illustrating an example of a processing sequence of communication apparatuses according to the third example.

FIG. 11 is a diagram illustrating an example of a configuration of a Channel Usage Request frame and a Channel Usage Response frame according to an embodiment.

FIG. 12 is a diagram illustrating an example of a configuration of a Target Wake Time (TWT) Element according to an embodiment.

FIG. 13 is a diagram illustrating an example of a configuration of a TWT Element according to an embodiment.

### DESCRIPTION OF THE EMBODIMENTS

Hereinafter, embodiments will be described in detail with reference to the accompanying drawings. It should be noted that the following embodiments are not intended to limit the scope of the claims. Although multiple features are described in the embodiments, not all of these features are essential to the present disclosure, and the features may be combined arbitrarily. Furthermore, in the accompanying drawings, the same reference numerals are assigned to identical or similar components, and redundant descriptions are omitted.

### Embodiment

### System Configuration

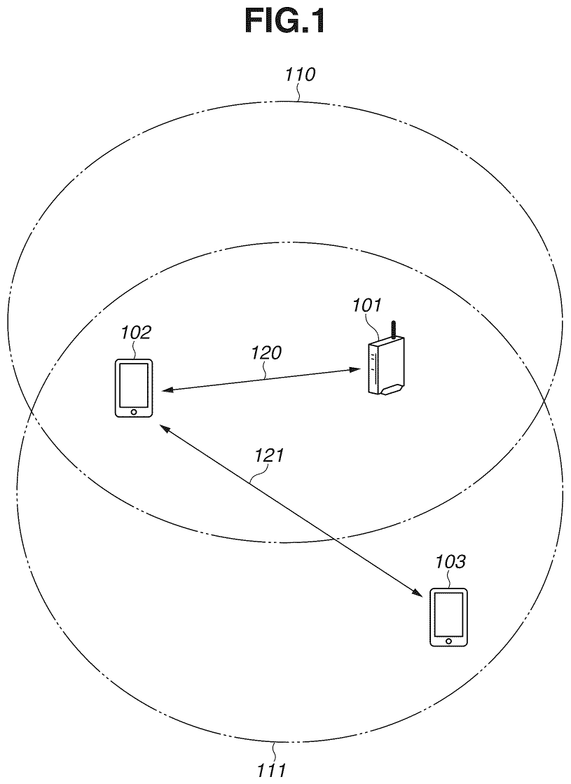

FIG. 1 is a diagram illustrating an example of a configuration of a wireless communication system according to an embodiment. FIG. 1 illustrates a network formed in the wireless communication system.

The wireless communication system includes three or more communication apparatuses. For example, as illustrated in FIG. 1, the wireless communication system may include communication apparatuses 101, 102, and 103. In a case where the communication apparatuses 101, 102, and 103 are not distinguished, the communication apparatuses 101, 102, and 103 may be referred to as the communication apparatus 100.

The communication apparatus 100 may be a wireless communication apparatus configured to perform wireless communication in compliance with the Institute of Electrical and Electronics Engineers (IEEE) 802.11 family of standards, including the IEEE 802.11bn standards. The communication apparatus 100 may include a station (STA) function configured to perform wireless communication in compliance with the IEEE 802.11 family of standards. The communication apparatus 100 may include an access point (AP) function that complies with the IEEE 802.11 family of standards. The IEEE 802.11bn standards may also be referred to as Ultra High Reliability (UHR) standards. UHR is short for Ultra High Reliability. The IEEE 802.11 family of standards may include the IEEE 802.11a/b/g/n/ac/ax/be standards. These standards may be referred to as legacy standards. In other words, the communication apparatus 100 may support one or more legacy standards in addition to the IEEE 802.11bn standards. The communication apparatus 100 may also support one or more legacy standards and may not support the IEEE 802.11bn standards.

A network 110 formed by the communication apparatuses 101 and 102 defines the range within which the communication apparatuses 101 and 102 can communicate. In other words, within the range of the network 110, the communication apparatus 102 can receive a signal transmitted by the communication apparatus 101, and a signal transmitted by the communication apparatus 102 may be received by the communication apparatus 101. The communication apparatus 102 can receive a signal transmitted by the communication apparatus 103, and a signal transmitted by the communication apparatus 102 may be received by the communication apparatus 103. The communication apparatuses 101 and 102 are in a connected state, and the communication apparatuses 102 and 103 are in a connected state.

The communication apparatus 100 may also support another communication standard, such as Bluetooth®, Near Field Communication (NFC), Ultra-Wide Band (UWB), ZigBee®, or Multi Band OFDM Alliance (MBOA), in addition to the IEEE 802.11 family of standards. NFC is short for Near Field Communication, UWB is short for Ultra-Wide Band, and MBOA is short for Multi Band Orthogonal Frequency-Division Multiplexing Alliance (Multi Band OFDM Alliance). UWB includes wireless USB, wireless 1394, WiNET, and the like. The communication apparatus 100 may support a communication standard for wired communication, such as a wired local area network (wired LAN).

The communication apparatuses 100 may include a function that discovers each other in accordance with a Wi-Fi Direct (WFD) standard and establishes a communication link. For example, in an establishment procedure compliant with a WFD standard, one of the communication apparatuses 102 and 103 may serve the role as a Group Owner (abbreviated as GO) and the other may serve the role as a Client (abbreviated as CL or CLI). In the example illustrated in FIG. 1, the communication apparatus 102 may operate as a GO, provide a communication parameter to the communication apparatus 103, and establish (or create) a network 111. On the other hand, the communication apparatus 103, which operates as a CL, may receive the communication parameter from the communication apparatus 102 and join the network 111. The communication apparatus 103 may operate as a GO, and the communication apparatus 102 may operate as a CL. Thus, in this case, the communication apparatus 103 may establish or create a network. The parameter may be passed from the CL to the GO using a Bootstrapping method, which will be described below. In this case, the communication apparatus 102 may operate as a temporary AP.

For example, the communication apparatus 102 may notify the communication parameter to another communication apparatus by notifying the other communication apparatus of a Beacon. WFD is an example of Peer-to-Peer (P2P) and may be referred to as P2P in the present specification and the drawings.

Alternatively, the communication apparatus 100 may include a function that establishes a communication link based on an infrastructure connection. For example, one of the communication apparatuses 101 and 102 may serve the role as an AP and the other may serve the role as a STA. In the example illustrated in FIG. 1, the communication apparatus 101 may operate as an AP, provide the communication parameter to the communication apparatus 102, and establish or create the network 110. On the other hand, the communication apparatus 102, which operates as a STA, may join the network 110 based on the communication parameter received from the communication apparatus 101. The communication apparatus 102 may operate as an AP, and the communication apparatus 101 may operate as a STA. Thus, in this case, the communication apparatus 102 may establish or create a network.

According to the present embodiment, a connection between the communication apparatuses 101 and 102 is an infrastructure connection for communication between the AP and the STA, and a connection between the communication apparatuses 102 and 103 is a WFD connection for communication between the GO and the CL. The communication between the AP and the STA and the communication between the GO and the CL use a different communication method from each other. However, both connections may be infrastructure connections or WFD connections.

FIG. 1 illustrates a state where three communication apparatuses 100 (e.g., the communication apparatuses 101, 102, and 103) are present, but four or more communication apparatuses 100 may form the networks 110 and 111. In this case, each communication apparatus 100 may connect to another communication apparatus 100, or a single communication apparatus 100 may operate as a hub to connect other communication apparatuses 100. For example, the network 110 may be established or created based on the communication parameter provided by the communication apparatus 101 that serves the role as an AP, and the plurality of communication apparatuses 100 that serves the role as a STA may join the network 110.

Each communication apparatus 100 may be any electronic device, including but not limited to a smartphone, a tablet, a mobile phone, a personal computer (PC), a video camera, a headset, a printer, a display, and the like. The communication apparatus 101 may be any electronic device, including but not limited to a wireless LAN router, a PC, and the like. Each communication apparatus 100 may be an information processing apparatus, such as a wireless chip, configured to perform wireless communication in compliance with the IEEE 802.11bn standard.

The communication apparatuses 100 may communicate using a wireless signal in frequency bands such as 2.4 GHz, 3.6 GHz, 5 GHz, and 6 GHz, as well as millimeter-wave frequency bands such as 45 GHz and 60 GHz. The frequency bands used by the communication apparatuses 100 are not limited to those described above and may also include, for example, the Sub1 GHz band and the like. The communication apparatuses 100 may communicate using bandwidths such as 20 MHz, 40 MHz, 80 MHz, 160 MHz, 320 MHz, 540 MHz, 640 MHz, 1080 MHz, and 2160 MHz. The bandwidths used by the communication apparatuses 100 are not limited to those described above and may also include, for example, 240 MHz, 4 MHz, and the like. In the IEEE 802.11 family of standards, a frequency channel using a bandwidth of 20 MHz is defined as a basic channel across frequency bands such as 2.4 GHz, 5 GHz, and 6 GHz. In the standards, a plurality of channels that can be used is defined for each of the 2.4 GHz, 5 GHz, and 6 GHz frequency bands. In the standards, a channel can be used in combination with another adjacent channel. According to the present embodiment, the user of a channel in combination with another adjacent channel is sometimes referred to as channel bonding. A channel group formed by a single channel or two or more adjacent channels is sometimes referred to as a communication link (or simply a link). Specifically, a single link formed by two 20 MHz channels uses 40 MHz of bandwidth. The communication apparatus 100 may be a STA multi-link device (STA MLD) or an AP multi-link device (AP MLD) that supports Multi-Link to establish a plurality of links simultaneously and perform simultaneous communication over the plurality of links. In FIG. 1, a single wireless link (e.g., link 120) is established between the communication apparatuses 101 and 102, and a single wireless link (e.g., link 121) is established between the communication apparatuses 102 and 103.

### Apparatus Configuration

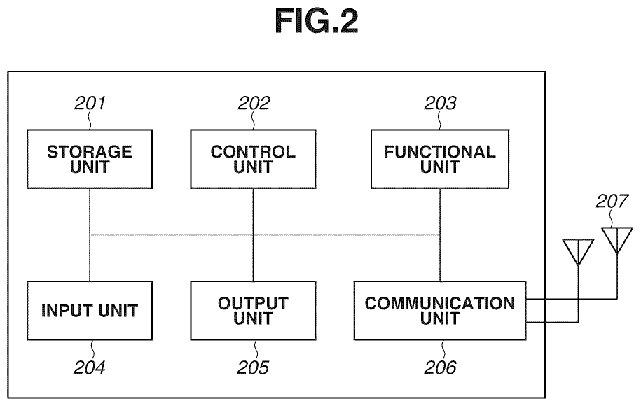

FIG. 2 is a diagram illustrating an example of a hardware configuration of the communication apparatus 100 according to the present embodiment. The communication apparatus 100 includes a storage unit 201, a control unit 202, a functional unit 203, an input unit 204, an output unit 205, a communication unit 206, and an antenna 207. As the antenna 207, a single antenna may be present, or a plurality of antennas may be present.

The storage unit 201 is composed of one or more memory devices, such as a read-only memory (ROM) and a random access memory (RAM), and stores various types of information, such as a computer program for executing various operations, which will be described below, and a communication parameter for wireless communication. ROM is short for Read Only Memory, and RAM is short for Random Access Memory. In addition to the memory devices such as a ROM and a RAM, a storage medium such as a flexible disk, a hard disk, a solid state drive (SSD), an optical disk, a magneto-optical disk, a compact disc ROM (CD-ROM), a compact disc recordable (CD-R), a magnetic tape, a non-volatile memory card, or a digital versatile disc (DVD) may also be used as the storage unit 201. SSD is short for Solid State Drive. CD-ROM is short for Compact Disc Read Only Memory. CD-R is short for Compact Disc Recordable. DVD is short for Digital Versatile Disc. The storage unit 201 may include a plurality of memory devices and the like. The storage unit 201 may store setting information input to the self-apparatus by a user, a remaining amount of a battery of the self-apparatus, information about a state of the self-apparatus, such as information specifying whether the self-apparatus is executing a power-saving operation, and the like.

The control unit 202 is composed of one or more processors, such as a central processing unit (CPU) and a micro-processing unit (MPU), and controls the entire communication apparatus 100 by executing a computer program stored in the storage unit 201. CPU is short for Central Processing Unit, and MPU is short for Micro Processing Unit. The control unit 202 may be configured to control the entire communication apparatus 100 through coordination between a computer program stored in the storage unit 201 and an operating system (OS). The control unit 202 generates data and a signal (e.g., a wireless frame) to be transmitted via communication with another communication apparatus. Further, the control unit 202 may include a plurality of processors, such as a multi-core processor, and the plurality of processors may control the entire communication apparatus 100.

The control unit 202 controls the functional unit 203 to perform wireless communication and a predetermined process, such as image capturing, printing, and imaging. The functional unit 203 is hardware used to perform the predetermined process by the communication apparatus 100. For example, in a case where the communication apparatus 100 is a camera, the functional unit 203 is an imaging unit and performs an image capturing process. For example, in a case where the communication apparatus 100 is a printer, the functional unit 203 is a printing unit and performs a printing process. For example, in a case where the communication apparatus 100 is a projector, the functional unit 203 is a projecting unit and performs a projecting process. Data to be processed by the functional unit 203 may be data stored in the storage unit 201 or data communicated from another communication apparatus via the communication unit 206, which will be described below.

The input unit 204 receives various operations from the user. The output unit 205 provides various types of output to the user via a monitor screen and a speaker. The output provided by the output unit 205 herein may include a display on the monitor screen, audio output from the speaker, vibration output, and the like. The input unit 204 and the output unit 205 may be realized as a single module, such as a touch panel. Each of the input unit 204 and the output unit 205 may be integrated with or separated from the communication apparatus 100.

The communication unit 206 controls wireless communication in compliance with the IEEE 802.11bn standard. The communication unit 206 may also control wireless communication in compliance with another standard of the IEEE 802.11 family, in addition to the IEEE 802.11bn standard, and wired communication, such as wired LAN communication. The communication unit 206 controls the antenna 207 to transmit and receive the signal for wireless communication generated by the control unit 202. The communication unit 206 may be composed of a plurality of communication circuits corresponding to the plurality of links, respectively. In a case where the communication apparatus 100 also supports other standards, such as NFC and Bluetooth, in addition to the IEEE 802.11bn standard, the communication unit 206 may also control wireless communication in compliance with those communication standards. In a case where the communication apparatus 100 is configured to perform wireless communication in compliance with a plurality of communication standards, a separate communication unit and a separate antenna may be included for each of the communication standards. The communication apparatus 100 communicates data, such as image data, document data, and video data, with a partner communication apparatus via the communication unit 206.

The antenna 207 may be configured separately from the communication unit 206 or integrated with the communication unit 206 as a single module.

The antenna 207 is an antenna configured to communicate using bandwidths such as 2.4 GHz, 5 GHz, and 6 GHz. According to the present embodiment, two or more antennas may be included, and in a case where the communication unit 206 is composed of a plurality of communication units, a separate antenna may be included for each of the communication units. Alternatively, a different antenna may be included for each frequency band.

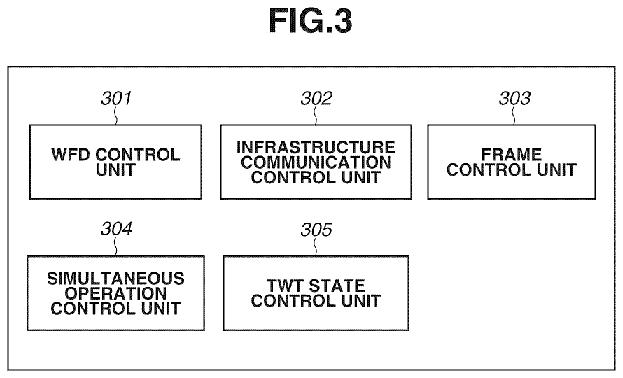

FIG. 3 is a diagram illustrating an example of a functional configuration of the communication apparatus 100 according to the present embodiment. The communication apparatus 100 includes a WFD control unit 301, an infrastructure communication control unit 302, a frame control unit 303, a simultaneous operation control unit 304, and a Target Wake Time (TWT) state control unit 305.

The WFD control unit 301 controls WFD communication. For example, the WFD control unit 301 controls or performs a process for discovering a partner apparatus based on a frame defined in the WFD standard and exchanging a parameter and establishing a connection using Wi-Fi Protected Setup (WPS) or Bootstrapping. WPS is short for Wi-Fi Protected Setup. The process controlled or performed by the WFD control unit 301 may include, for example, a Probe process, a Service Discovery Frame (SDF) process, a WPS process, a Bootstrapping process, and a GO Negotiation process. The WFD control unit 301 may transmit a WFD communication frame generated by the frame control unit 303 and receive a WFD communication frame from another communication apparatus. The WFD control unit 301 is an example of a transmission unit, a reception unit, a transmission/reception unit, or a communication unit.

The infrastructure communication control unit 302 controls infrastructure communication. For example, the infrastructure communication control unit 302 controls or performs a process for discovering a partner apparatus using a Beacon or the like and establishing a connection with the partner apparatus by performing an Association process. The process controlled or performed by the infrastructure communication control unit 302 may include, for example, a Probe process, an Authentication process, an Association process, and a 4-way handshake process. The infrastructure communication control unit 302 may transmit an infrastructure communication frame generated by the frame control unit 303 and receive an infrastructure communication frame from another communication apparatus. The infrastructure communication control unit 302 is an example of a transmission unit, a reception unit, a transmission/reception unit, or a communication unit.

The frame control unit 303 receives an instruction from the WFD control unit 301 and the infrastructure communication control unit 302 and generates a frame.

The simultaneous operation control unit 304 consolidates the communication parameters and communication periods for use by the WFD control unit 301 and the infrastructure communication control unit 302 and performs processing. The simultaneous operation control unit 304 determines a period for use by the WFD control unit 301 and a period for use by the infrastructure communication control unit 302 (e.g., a TWT Service Period (TWT SP) as a GO (or CL) and a TWT SP as a STA (or AP), which will be described below). The simultaneous operation control unit 304 is an example of a determination unit.

The TWT state control unit 305 receives information from the simultaneous operation control unit 304 and determines a TWT state in both WFD communication and infrastructure communication.

### Operations

Next, various operations, such as a flow of a process performed by the communication apparatus 100 and a processing sequence in a wireless communication system, will be described.

### First Example

In the present example, the communication apparatus 101 operates as an AP, the communication apparatus 102 operates as a STA and a GO, and the communication apparatus 103 operates as a CL.

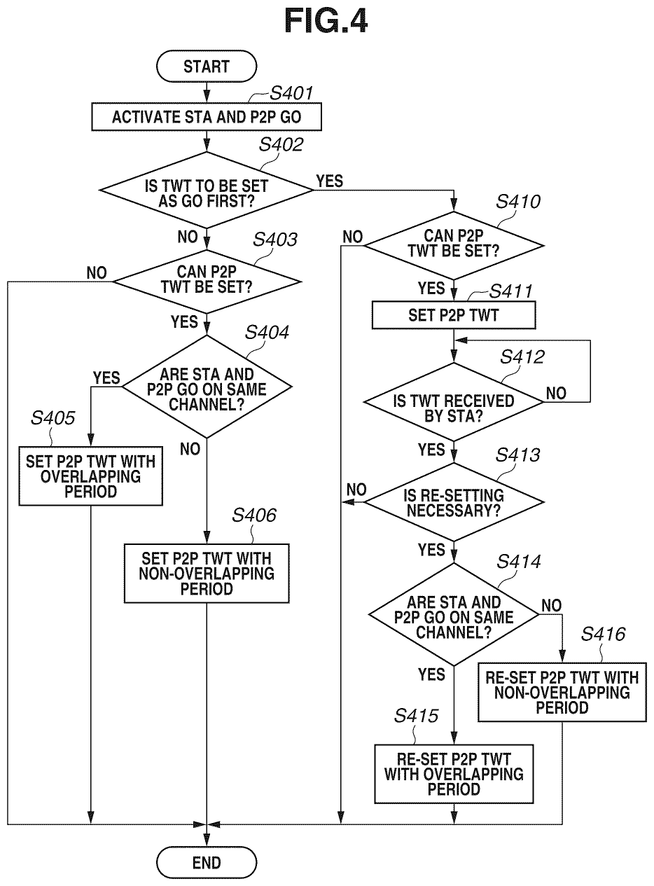

FIG. 4 is a flowchart illustrating an example of a flow of a process performed by the control unit 202 executing a program stored in the storage unit 201 of the communication apparatus 102.

Specifically, FIG. 4 illustrates an example of a process in which a TWT is set through simultaneous operation between a STA and a WFD GO. More specifically, FIG. 4 illustrates an example of a process of setting a TWT after the communication apparatus 102 establishes an infrastructure connection with the communication apparatus 101 and a WFD connection with the communication apparatus 103. The process is started when the communication apparatus 102 establishes an infrastructure connection with the communication apparatus 101 and a WFD connection with the communication apparatus 103. The process may be started in a case where the communication apparatus 102 establishes only one of the connections. The process may be repeated after the simultaneous operation process.

In step S401, the communication apparatus 102 is activated as a STA and connects to the communication apparatus 101 operating as an AP. In step S401, the communication apparatus 102 is activated as a WFD (P2P) GO and connects to the communication apparatus 103 operating as a CL.

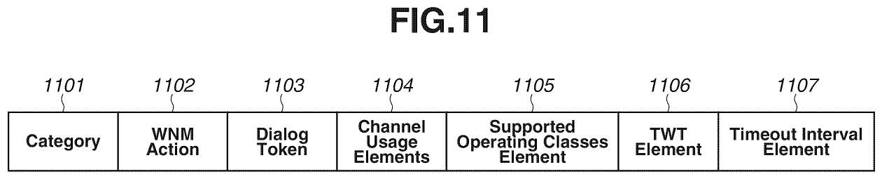

Next, in step S402, the communication apparatus 102 determines whether to set a TWT as a GO first or as a STA first. The communication apparatus 102 performs this determination based on whether the communication apparatus 102 first operates as a GO and transmits a TWT Setup frame to the communication apparatus 103 or the communication apparatus 102 first operates as a STA and receives a TWT Setup frame from the communication apparatus 101. The TWT Setup frame may be a Beacon frame including a TWT Element. Alternatively, a TWT Element may be included in a Probe Response frame, an Association Response frame, or the like. Alternatively, the communication apparatus 102 may transmit a Probe Request frame, an Association Request frame, or the like including a TWT Element to request TWT setup as a STA. Alternatively, the communication apparatus 102 may use a Channel Usage Request frame illustrated in FIG. 11, which will be described below, to request TWT setup to the communication apparatus 101. Alternatively, the communication apparatus 102 as a GO may receive a TWT setup request frame from the communication apparatus 103 operating as a CL. The TWT Element is an example of information about a TWT SP. The TWT SP may also be referred to as a period for communicating with a partner communication apparatus using a communication method, a period during which communication can be performed with a partner communication apparatus using a communication method, or the like.

In a case where the communication apparatus 102 as a STA receives a TWT setup from the communication apparatus 101 (NO in step S402), in step S403, the communication apparatus 102 checks or determines (the same applies below) whether a TWT can be set or activated or executed in WFD. The communication apparatus 102 may determine whether a TWT can be set in WFD by determining whether, for example, only a communication apparatus that supports TWT has joined the network created by the communication apparatus 102 as a WFD GO. In a case where at least one communication apparatus that does not support TWT or supports TWT but cannot operate with TWT on a network created by a GO has joined the network created by the communication apparatus 102 as a GO, the communication apparatus 102 determines as follows. Specifically, the communication apparatus 102 determines that a TWT cannot be set on the network created by the communication apparatus 102 as a WFD GO. Otherwise, the communication apparatus 102 determines that a TWT can be set on the network created by the communication apparatus 102 as a WFD GO.

In a case where a TWT cannot be set in WFD (NO in step S403), the communication apparatus 102 receives a TWT setup notification from the communication apparatus 101 without modification, and the process is terminated.

On the other hand, in a case where a TWT can be set in WFD (YES in step S403), in step S404, the communication apparatus 102 checks whether a channel on which the communication apparatus 102 operates as a STA and a channel on which the communication apparatus 102 operates as a GO are the same.

In a case where the channels are the same (YES in step S404), in step S405, the communication apparatus 102 sets a TWT SP also on the network created by the communication apparatus 102 as a GO so that the TWT SP fully overlaps the TWT SP received from the communication apparatus 101. This makes it possible for the communication apparatus 102 to align the TWT SPs as a STA and as a GO, and by setting the period outside the TWT SPs to a state in which transmission and reception can be performed (e.g., a period during which transmission and reception can be performed), power savings are achieved. The TWT SPs may be set to overlap partially. This makes it easier to perform frame exchange that is inevitably required during the TWT SPs. Alternatively, the communication apparatus 102 may set non-overlapping, continuous periods as the TWT SPs as a STA and as a GO. A preparatory period during which a frame can be transmitted or received is allocated before and after the TWT SP, which makes it possible to reduce the overhead. Reducing overhead enables power-saving operation. The expression “set a TWT SP” (and any expression similar to this) may be replaced by the expression “determine a TWT SP” (and any expression similar to this).

On the other hand, in a case where the channels are different (NO in step S404), in step S406, the communication apparatus 102 sets a TWT SP on the network created by the communication apparatus 102 as a GO so that the TWT SP does not (e.g., even partially) overlap the TWT SP received from the communication apparatus 101. In a case where the communication apparatus 102 can operate on only one channel at a time, if the TWT SPs for the communication apparatuses 101 and 103 overlap, the communication apparatus 102 may not be able to perform one of the communications. Thus, the TWT SPs are set in step S405 as described above, thereby enabling the communication apparatuses 101 and 103 to continue communication. This makes it possible to improve the reliability of communication.

In a case where the communication apparatus 102 is to set a TWT as a GO first (YES in step S402), in step S410, the communication apparatus 102 checks whether a TWT can be set or activated or executed as a GO. The communication apparatus 102 determines whether a TWT can be set as a GO based on whether a communication apparatus that cannot execute TWT in WFD is present on the network created as a GO. For example, in a case where a WFD Revision 1 (WRD R1) communication apparatus that operates as a WFD communication apparatus but does not support TWT is present, or in a case where a communication apparatus that does not support WFD and operates as a STA is present, the communication apparatus 102 determines as follows. Specifically, the communication apparatus 102 determines the communication apparatus as a communication apparatus that cannot execute TWT. In this case, the communication apparatus 102 does not set a TWT as a GO at this time (NO in step S410), and in a case where a TWT setup notification is received from the communication apparatus 101, the communication apparatus 102 follows the notified setting.

On the other hand, in a case where the communication apparatus 102 can set a TWT as a GO (YES in step S410), in step S411, the communication apparatus 102 sets a TWT as a GO. For example, the communication apparatus 102 may transmit a Beacon frame including a TWT Element as a GO. Alternatively, the communication apparatus 102 may notify a TWT Element using either a Probe Response frame or an Association Response frame while establishing a connection with the communication apparatus 103. Alternatively, the communication apparatus 102 may set a TWT SP based on a TWT setup request from the communication apparatus 103 (e.g., a Channel Usage Request frame received from the communication apparatus 103). In other words, the communication apparatus 102 may set a TWT SP in a Channel Usage Response frame.

In step S412, after setting a TWT as a GO, the communication apparatus 102 checks whether a TWT can be set also on the network that the communication apparatus 102 has joined as a STA. Unless a TWT is set on the network that the communication apparatus 102 has joined as a STA, the communication apparatus 102 operates as a GO solely based on the TWT set as a GO. The communication apparatus 102 may check whether a TWT can be set also on the network that the communication apparatus 102 has joined as a STA, for example, by transmitting an Association Request frame when joining the network of the communication apparatus 101. Alternatively, the communication apparatus 102 may check whether a TWT can be set also on the network that the communication apparatus 102 has joined as a STA by transmitting a Channel Usage Request frame to the communication apparatus 101 after joining the network. Alternatively, the communication apparatus 102 may wait for a Beacon frame, a Probe Response frame, an Association Response frame, a Channel Usage Response frame, or the like from the communication apparatus 101. Details of a request issued to the communication apparatus 101 by the communication apparatus 102 when checking whether a TWT can be set as a STA may be based on steps S414 to S416. In other words, the communication apparatus 102 may determine whether to set TWT SPs with overlapping or non-overlapping periods for the network that the communication apparatus 102 has joined as a STA and the network created by the communication apparatus 102 as a GO, based on whether the STA and the GO operate on the same channel. Then, the communication apparatus 102 may issue a request to set TWT SPs as determined to the communication apparatus 101. Alternatively, the communication apparatus 102 may issue a request to set a TWT SP so that the TWT SP does not (e.g., even partially) overlap the TWT SP set as a GO to the communication apparatus 101. Until the communication apparatus 101 determines a TWT SP, the communication apparatus 102 performs operation related to TWT only during the TWT SP set by the communication apparatus 102 as a GO. The communication apparatus 102 operates without a TWT setup during communication with the communication apparatus 101.

In a case where a TWT is set by the communication apparatus 101, in step S413, the communication apparatus 102 checks whether it is necessary to re-set the TWT SP for the network on which the communication apparatus 102 operates as a GO. For example, in a case where the TWT SP set as a GO and the TWT SP set for the network that the communication apparatus 102 has joined as a STA overlap partially or fully although the GO and the STA operate on different channels, it is necessary to re-set the TWT SP. This re-setting is necessary for continuing communication with both communication apparatuses. Further, in a case where the TWT SP set as a GO and the TWT SP set for the network that the communication apparatus 102 has joined as a STA do not overlap (e.g., even partially) although the GO and the STA operate on the same channel, the TWT SPs may be re-set to overlap. This makes it possible for the communication apparatus 102 to align the periods during which a communication apparatus can transmit or receive a frame, thereby realizing simultaneous operation with enhanced power saving.

In a case where it is necessary to re-set the TWT SP (YES in step S413), in step S414, the communication apparatus 102 checks whether the channel on which the communication apparatus 102 operates as a STA and the channel on which the communication apparatus 102 operates as a GO are the same.

In a case where the channels are the same (YES in step S414), in step S415, the communication apparatus 102 sets a TWT SP also on the network created by the communication apparatus 102 as a GO so that the TWT SP overlaps the TWT SP received from the communication apparatus 101. On the other hand, in a case where the channels are different (NO in step S414), in step S416, the communication apparatus 102 sets a TWT SP for the network created by the communication apparatus 102 as a GO so that the TWT SP does not (e.g., even partially) overlap the TWT SP received from the communication apparatus 101. Specific operations in steps S414 to S416 are similar to those in steps S405 to S407, so that the description is omitted.

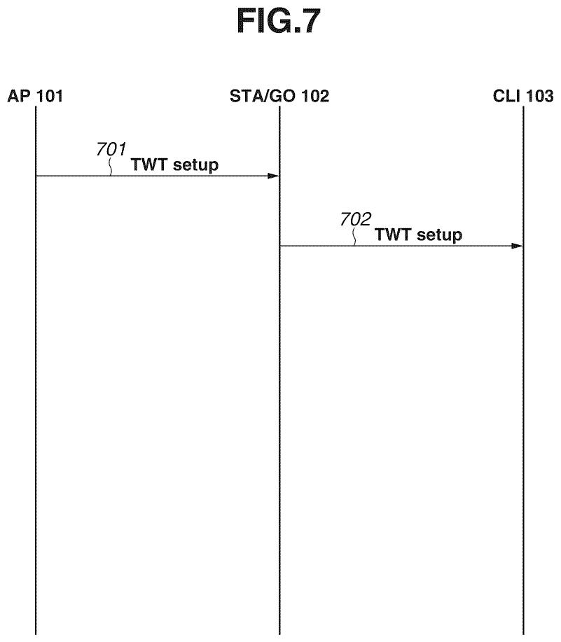

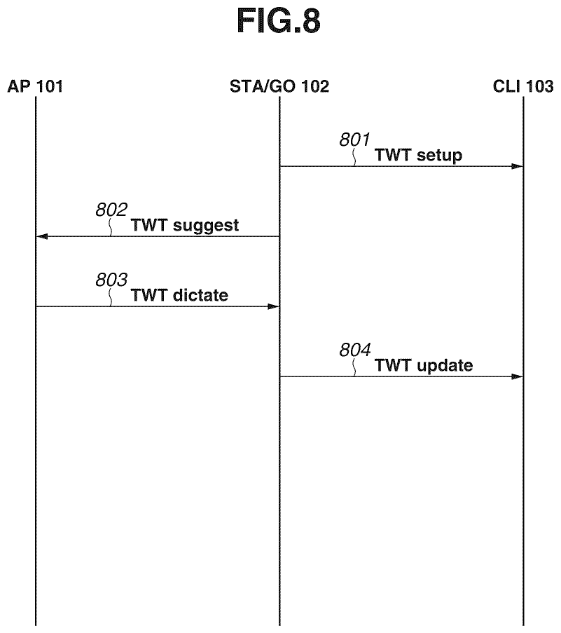

FIGS. 7 and 8 are diagrams illustrating examples of processing sequences of communication apparatuses for setting a TWT according to the first example.

FIG. 7 illustrates an example of a case where a TWT is set between the communication apparatuses 101 and 102 first and then a TWT is set between the communication apparatuses 102 and 103. For example, the case illustrated in FIG. 7 may apply to a case where the communication apparatuses 102 and 101 are connected first and then the communication apparatuses 102 and 103 are connected.

The communication apparatus 101 appends or includes a TWT Element to a Beacon frame, a Probe Response frame, an Association Response frame, or the like and then transmits the resulting frame (701: TWT setup). This makes it possible for the communication apparatus 101 to notify the TWT SP to the STA connected to the communication apparatus 101.

The communication apparatus 102 checks the TWT SP based on the TWT Element received from the communication apparatus 101. Subsequently, the communication apparatus 102 transmits a frame including a TWT Element to the communication apparatus 103 to determine a TWT SP between the communication apparatuses 102 and 103 (702: TWT setup). The frame transmitted by the communication apparatus 102 at this time may be a Beacon frame, a Probe Response frame, or an Association Response frame. Alternatively, the frame transmitted by the communication apparatus 102 at this time may be a Channel Usage Response frame. A TWT SP set in the TWT Element transmitted by the communication apparatus 102 is determined based on the TWT SP included in the TWT Element received from the communication apparatus 101 by the communication apparatus 102. For example, in a case where the channel on which the communication apparatus 102 operates as a STA and the channel on which the communication apparatus 102 operates as a GO are the same, the communication apparatus 102 sets the exact same period, a partially overlapping period, or a continuous period. In a case where the channel on which the communication apparatus 102 operates as a STA and the channel on which the communication apparatus 102 operates as a GO are different, the communication apparatus 102 sets a period so that the TWT SPs do not overlap at any time. This may be realized, for example, by aligning a period formed by adding a TWT Wake Interval and a TWT Wake Duration, which will be described below, and shifting only a Timing Synchronization Function (TSF) value specified by a Target Wake Time. TSF is short for Timing Synchronization Function.

FIG. 8 illustrates an example of a case where a TWT is set between the communication apparatuses 102 and 103 first and then a TWT is set between the communication apparatuses 101 and 102. For example, the case illustrated in FIG. 8 may apply to a case where the communication apparatuses 102 and 103 are connected first and then the communication apparatuses 102 and 101 are connected.

The communication apparatus 102 appends or includes a TWT Element to a Beacon frame, a Probe Response frame, an Association Response frame, or the like and then transmits the resulting frame (801: TWT setup). This makes it possible for the communication apparatus 102 to notify a TWT SP to the CL connected to the communication apparatus 102. A value of 0 (Request TWT) may be stored in a TWT Setup Command sub-field 1232, which will be described below, at this time.

The communication apparatus 102 issues a request for a TWT SP to the communication apparatus 101 based on the settings configured as a GO (802: TWT suggest). A frame used by the communication apparatus 102 at this time may use an Association Request frame or a Channel Usage Request frame. Alternatively, this frame may be omitted. The TWT SP requested by the communication apparatus 102 is determined based on the TWT SP set by the communication apparatus 102 as a GO. For example, in a case where the channel on which the communication apparatus 102 operates as a STA and the channel on which the communication apparatus 102 operates as a GO are the same, the communication apparatus 102 sets the exact same period, a partially overlapping period, or a continuous period. In a case where the channel on which the communication apparatus 102 operates as a STA and the channel on which the communication apparatus 102 operates as a GO are different, the communication apparatus 102 sets a period so that the TWT SPs do not overlap at any time. This may be realized, for example, by aligning a period formed by adding a TWT Wake Interval and a TWT Wake Duration, which will be described below, and shifting only a TSF value specified by a Target Wake Time. The value stored in the TWT Setup Command sub-field 1232, which will be described below, at this time may be 1 (Suggest TWT) or 2 (Demand TWT).

Meanwhile, the communication apparatus 101 may set a TWT SP with a period different from the request (803: TWT dictate). The TWT SP from the communication apparatus 101 may be transmitted again separately using a Beacon frame after responding to the TWT suggest 802. In a case where the communication apparatus 101 accepts the TWT suggest 802, the value stored in the TWT Setup Command sub-field 1232, which will be described below, at this time may be 4 (Accept TWT). In a case where the communication apparatus 101 rejects or denies the TWT suggest 802, the communication apparatus 101 may set a value of 5 (Alternate TWT) in the TWT Setup Command sub-field 1232, which will be described below, at this time and request a new TWT setup. Alternatively, the communication apparatus 101 may set a value of 6 (Dictate TWT) in the TWT Setup Command sub-field 1232, which will be described below, at this time and present a new TWT setup. Alternatively, the communication apparatus 101 may set a value of 7 (Reject TWT) in the TWT Setup Command sub-field 1232, which will be described below, at this time for rejection. In a case where the communication apparatus 101 transmits a TWT SP again using a Beacon frame, the communication apparatus 101 may set a value of 0 (Request TWT) in the TWT Setup Command sub-field 1232, which will be described below, at this time. In the example illustrated in FIG. 8, a value of 6 (Dictate TWT) is set in the TWT Setup Command sub-field 1232 as described above.

The communication apparatus 102 receives the TWT dictate 803 and determines whether it is necessary to re-set the TWT SP set by the GO. In a case where the communication apparatus 102 determines that re-setting is necessary, the communication apparatus 102 updates the TWT SP and transmits the updated TWT SP to the communication apparatus 103 (804: TWT update). The communication apparatus 102 may set a value of 0 (Request TWT) in the TWT Setup Command sub-field 1232, which will be described below, at this time. The TWT update 804 may be transmitted using a Beacon frame or a Channel Usage Request frame.

The communication apparatus 102 can calculate and set the TWT SP during simultaneous operation as described above.

FIG. 11 illustrates an example of frames used during the communications 801 to 804 in the example illustrated in FIG. 8. According to the present example, a Channel Usage Request frame or a Channel Usage Response frame is used during the communications 801 to 804. FIG. 11 is a diagram illustrating an example of configurations of a Channel Usage Request frame and a Channel Usage Response frame according to the present embodiment and the present example.

The frames include a Category field 1101, a Wireless Network Management (WNM) Action field 1102, a Dialog Token field 1103, and a Channel Usage Elements field 1104. The frames also include a Supported Operating Classes Element field 1105, a TWT Element field 1106, and a Timeout Interval Element field 1107.

The Category field 1101 stores a value of 10, which indicates that this frame is a WNM Action frame.

The WNM Action field 1102 stores a value of 21, which indicates that this frame is a Channel Usage Request frame, or a value of 22, which indicates that this frame is a Channel Usage Response frame.

The Dialog Token field 1103 is a field that specifies an identifier or identification information (ID) assigned to perform a procedure across a plurality of frame exchanges. For example, a value of 5 may be stored in the Dialog Token field 1103 in a Channel Usage Request frame. In this case, a value of 5 is also stored in the Dialog Token field 1103 in a Channel Usage Response frame that is a response to the Channel Usage Request frame, and the Channel Usage Response frame is transmitted.

The Channel Usage Elements field 1104 specifies a channel available for use by the communication apparatus 100.

The Supported Operating Classes Element field 1105 specifies a list of operating classes supported by the communication apparatus 100.

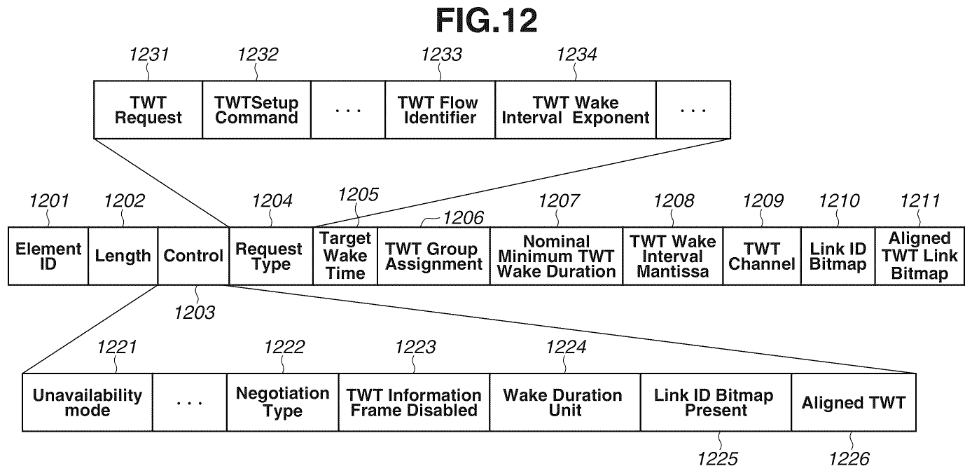

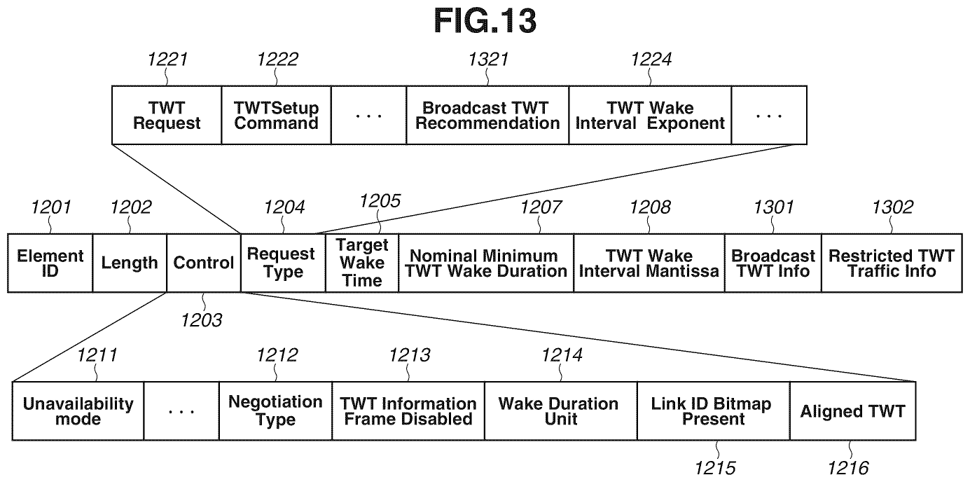

The TWT Element field 1106 stores a TWT Element. Specific examples of a TWT Element used in the TWT setup or the like will be described below with reference to FIGS. 12 and 13.

The Timeout Interval Element field 1107 specifies a time-out period for a procedure.

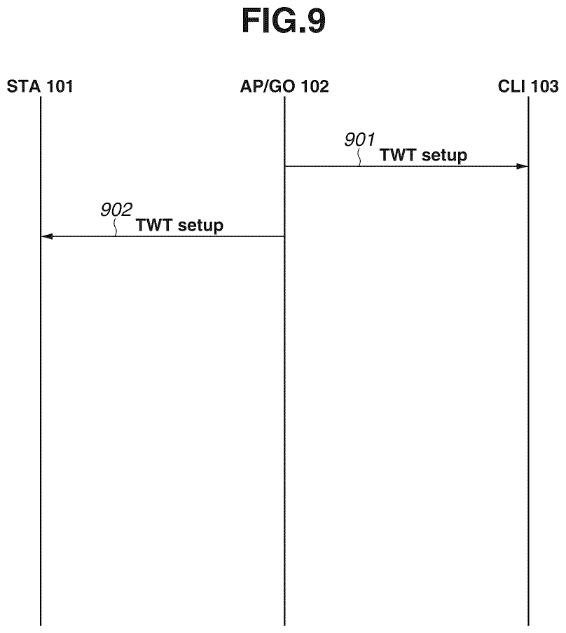

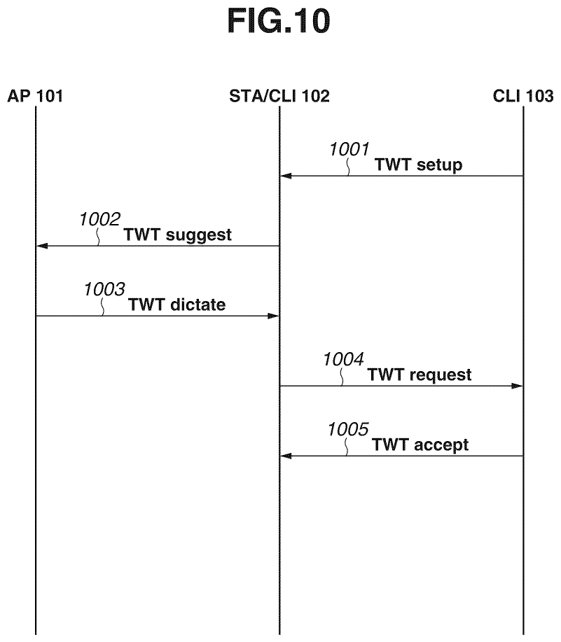

Examples of TWT Elements included in frames transmitted or received in the examples illustrated in FIGS. 7 and 8 (and examples illustrated in FIGS. 9 and 10) will be described with reference to FIGS. 12 and 13.

FIG. 12 is a diagram illustrating an example of a configuration of a TWT Element used to set an Individual TWT for setting a TWT SP individually according to the present embodiment and the present example.

The TWT Element includes an Element ID field 1201, a Length field 1202, a Control field 1203, and a Request Type field 1204. The TWT Element also includes a Target Wake Time field 1205, a TWT Group Assignment field 1206, and a Nominal Minimum TWT Wake Duration field 1207. The TWT Element also includes a TWT Wake Interval Mantissa field 1208 and a TWT Channel field 1209. The TWT Element includes a Link ID Bitmap field 1210 and an Aligned TWT Link Bitmap field 1211.

The Element ID field 1201 stores a value of 216, which indicates that this Element is a TWT Element.

The Length field 1202 is a field that specifies the length of the Element starting from the Length field 1202.

The Control field 1203 is a field configured to present the type of the TWT Element field and the presence or absence of subsequent fields. The Control field 1203 includes an Unavailability Mode sub-field 1221 and a Negotiation Type sub-field 1222. The Control field 1203 also includes a TWT Information Frame Disabled sub-field 1223 and a Wake Duration Unit sub-field 1224. The Control field 1203 includes a Link ID Bitmap Present sub-field 1225 and an Aligned TWT sub-field 1226.

The Unavailability Mode sub-field 1221 is a field that specifies whether it is an Unavailability Mode. In a case where a value of 1 is stored in the field, this indicates that it is the Unavailability Mode, and in a case where a value of 0 is stored in the field, this indicates that it is not the Unavailability Mode. According to the present embodiment, a value of 0 is stored in the field.

The Negotiation Type sub-field 1222 is a field that specifies whether a TWT parameter (and thus the TWT Element) is intended for broadcast or individual use. The Negotiation Type sub-field 1222 is also a field that specifies whether a Wake Target Beacon Transmission Time (Wake TBTT) interval is specified. Since FIG. 12 illustrates an example of a TWT Element intended for individual use, the value in a first field is 0, which indicates that it is intended for individual use (and that an interval between individual TWT SPs is specified), in the example illustrated in FIG. 12.

The TWT Information Frame Disabled sub-field 1223 is a field that specifies whether to discard or invalidate TWT Information received by the STA. According to the present embodiment, the value in the field is 0, which indicates that TWT Information received by the STA will not be discarded (e.g., will not be invalidated).

The Wake Duration Unit sub-field 1224 is a field that specifies the unit of the time specified by the Nominal Minimum TWT Wake Duration field 1207. In a case where a value of 1 is stored in the field, this indicates that the unit is 256 us, and in a case where a value of 0 is stored in the field, this indicates that the unit is 1 TU. According to the present embodiment, a value of 1 is stored in the field.

A Link ID Bitmap Present sub-field 1215 is a field that indicates whether the Link ID Bitmap field 1210 is present. In a case where the Link ID Bitmap field 1210 is not present, the TWT Element is valid only for the link on which the TWT Element has been transmitted. In a case where the Link ID Bitmap field 1210 is present, the TWT Element is valid on the link specified by the Link ID Bitmap field 1210. In a case where a value of 1 is stored in the field, this indicates that the Link ID Bitmap field 1210 is present. In a case where a value of 0 is stored in the field, this indicates that the Link ID Bitmap field 1210 is not present. According to the present embodiment, a value of 1 is stored in the field.

The Aligned TWT sub-field 1226 is a field that indicates whether an Aligned TWT Link Bitmap field, which is used in a case where negotiations of TWT Elements across a plurality of links are performed collectively, is present. In a case where a value of 1 is stored in the field, this indicates that an Aligned TWT Link Bitmap field is present. In a case where a value of 0 is stored in the field, this indicates that an Aligned TWT Link Bitmap field is not present. According to the present embodiment, a value of 1 is stored in the field.

The Request Type field 1204 stores a parameter that indicates the request type of the TWT Element. In a case where a value of 0 is stored in the Unavailability Mode sub-field 1221 (i.e., according to the present embodiment), the Request Type field 1204 includes the following sub-fields. The Request Type field 1204 includes a TWT Request sub-field 1231 and the TWT Setup Command sub-field 1232. The Request Type field 1204 also includes a TWT Flow Identifier sub-field 1233 and a TWT Wake Interval Exponent sub-field 1234.

The TWT Request sub-field 1231 is a field that indicates whether it is the side requesting the value specified by the TWT Element or the side on which TWT is scheduled. During the communications 701 and 702 illustrated in FIG. 7 and the communications 801, 803, and 804 illustrated in FIG. 8, a value of 1, which indicates that it is the side requesting the value specified by the TWT Element, is designated in the sub-field 1231. In the rest of the TWT procedure (e.g., the communication 802 illustrated in FIG. 8), a value of 0 is designated in the sub-field 1231.

The TWT Setup Command sub-field 1232 is a field that indicates the negotiation type of the frame to which the TWT Element is appended. In a case where a value of 0 is stored in the field, this indicates that the type is Request. In a case where a value of 1 is stored in the field, this indicates that the type is Suggest. The Suggest (“1”) is designated in a case where a suggestion is to be offered to the partner apparatus. In a case where a value of 2 is stored in the field, this indicates that the type is Demand. The Demand (“2”) is designated in a case where a demand is to be issued to the partner apparatus. In a case where a value of 3 is stored in the field, this indicates that the type is TWT Grouping. The TWT Grouping (“3”) is designated in a case where responses to a plurality of different STAs are to be transmitted collectively. In a case where a value of 4 is stored in the field, this indicates that the type is Accept. The Accept (“4”) is designated in a case where a demand from the partner apparatus is to be accepted. In a case where a value of 5 is stored in the field, this indicates that the type is Alternate. The Alternate (“5”) is designated in a case where operation is to be performed with a setting different from that specified in the Suggest or Demand from the partner apparatus and an alternate setting is to be proposed to the partner apparatus. In a case where a value of 6 is stored in the field, this indicates that the type is Dictate. The Dictate (“6”) is designated in a case where operation is to be performed with a setting different from that specified in the Suggest or Demand from the partner apparatus and an alternate setting is to be presented to the partner apparatus.

The TWT Flow Identifier sub-field 1233 is a field that specifies an identifier (ID) for associating the series of TWT procedures. According to the present embodiment, a value of 0 is stored in the field.

The TWT Wake Interval Exponent sub-field 1234 is a field that specifies the length between the periods during which the communication parameter is limited, together with the TWT Wake Interval Mantissa field 1208. The periods correspond to the TWT SP designated by the TWT Element. According to the present embodiment, the length between the periods during which the communication parameter is limited is referred to as a TWT Wake Interval, and the unit of the length is μs. Specifically, the value specified by the sub-field 1234 is raised to the power of 2, and a value obtained by multiplying the result by the value specified by the TWT Wake Interval Mantissa field 1208 is determined as the TWT Wake Interval. The communication apparatuses may transition to a sleep state or doze state during a period other than the TWT SP in the TWT Wake Interval. The communication apparatuses do not perform transmission or reception (e.g., communication) during the sleep state. In this case, the period other than the TWT SP in the TWT Wake Interval may be referred to as a communication unavailable period or a period during which it is not possible to communicate. Alternatively, the communication apparatuses do not have to transition to the sleep state or doze state during the period other than the TWT SP in the TWT Wake Interval. In this case, the communication apparatuses may perform transmission or reception (e.g., communication) during the period other than the TWT SP in the TWT Wake Interval.

The Target Wake Time field 1205 is a field that specifies an 8-octet TSF time transmitted in a Beacon by the AP at the starting time of the TWT SP during which the AP is awake or activated (or in an awake or active state and performs communication. In a case where a value of 2, 3, or 4 is stored in the TWT Setup Command sub-field 1232, the Target Wake Time field 1205 may be omitted. In a case where a value of 0 or 1 is stored in the TWT Setup Command sub-field 1232, the Target Wake Time field 1205 specifies an 8-octet TSF time of the AP at the starting time from which the communication parameter is limited.

The TWT Group Assignment field 1206 is a field that provides an identifier of a TWT Group to which the STA is assigned. The TWT Group Assignment field 1206 may include a TWT Group ID, a TWT Unit, and a TWT Offset. The TWT Group ID specifies a 7-bit identifier of the TWT Group to which the STA is assigned. The TWT Unit specifies a time unit between TWT values within the TWT Group identified by the TWT Group ID. The TWT Offset specifies the position within the TWT Group to which the STA that has received the TWT Element belongs.

The Nominal Minimum TWT Wake Duration field 1207 is a field that specifies the length of the TWT SP in the unit specified by the Wake Duration Unit sub-field 1224.

The TWT Channel field 1209 is a field that presents a channel that negotiates as a temporary channel with the STA during the TWT SP. A bitmap is prepared starting from the lower sub-channels in 20 MHz units. The TWT SP is set on a channel corresponding to a bit set to a value of 1.

The Link ID Bitmap field 1210 is a field that uses a bitmap to indicate which Link ID the TWT Element parameter to be transmitted applies to. The TWT Element applies to a link specified by a Link ID corresponding to a bit set to a value of 1. The TWT Element is not applied to a link specified by a Link ID corresponding to a bit set to a value of 0.

The Aligned TWT Link Bitmap field 1211 is a field that uses a bitmap to indicate a Link to which the TWT SP also applies, together with the value specified by the Link ID Bitmap field 1210. A value of “1” indicates that the TWT SP applies. A bit that corresponds to a value of “0” in the Link ID Bitmap field 1210 also corresponds to a value of “0” in the Aligned TWT Link Bitmap field 1211.

FIG. 13 is a diagram illustrating an example of a configuration of a TWT Element used to set a Broadcast TWT to apply the TWT to every connected STA according to the present embodiment and the present example. The description of each field in FIG. 13 that corresponds to a field in FIG. 12 will be omitted.

The Request Type field 1204 includes a Broadcast TWT Recommendation sub-field 1321. The Broadcast TWT Recommendation sub-field 1321 is a field that indicates whether there is a recommendation for a frame to be transmitted during a Broadcast TWT SP and, in a case where there is a recommendation, specifies the recommended frame.

In a case where a value of 0 is stored in the sub-field 1321, this indicates that there is no limitation on the frames to be transmitted.

In a case where a value of 1 is stored in the sub-field 1321, this indicates a recommendation that the frames to be transmitted be limited to the following frames.
PS-Poll frame or QoS Null frame
QoS Control feedback
High Efficiency (HE) Trigger Based (TB) feedback Null Data PHY Protocol Data Unit (PPDU) (HE TB feedback NDP)
Bandwidth Query Report (BQR)
Buffer Status Report (BSR)
Sounding
Management frame
Control Response frame

In a case where a value of 2 is stored in the sub-field 1321, this indicates a recommendation that the frames to be transmitted be limited to the foregoing frames excluding the HE TB feedback NDP.

In a case where a value of 3 is stored in the sub-field 1321, this indicates that there is no limitation on the frames except for the following frames.
Traffic Indication Map (TIM) frame
Fast Initial Link Setup (FILS) Discovery frame including a TIM element

A Broadcast TWT Info field 1301 is a field that includes specific information about a broadcast TWT. The Broadcast TWT Info field 1301 includes a Broadcast TWT ID and a Broadcast TWT Persistence. The Broadcast TWT ID stores an identifier for a target Broadcast TWT in a case where the transmitting STA requests participation or a TWT to be provided is designated. The Broadcast TWT Persistence specifies the number of TBTTs during which the Broadcast TWT exists.

A Restricted TWT Traffic Info field 1302 is a field that is used to indicate whether a device other than the target STA can perform transmission. The Restricted TWT Traffic Info field 1302 may be omitted. In a case where a value of 0 is stored in the field, this indicates that there is no STA participating in the Restricted TWT. In a case where a value of 1 is stored in the field, this indicates that one or more STAs participate in the Restricted TWT. In a case where a value of 2 is stored in the field, this indicates that the possibility of accepting a new Restricted TWT is low. In a case where a value of 3 is stored in the field, this indicates that a non-transmitted BSSID performs Restricted TWT.

In a case where a STA demands a TWT, the STA requests an Individual TWT setup. In a case where an AP declares a TWT, the AP sets a Broadcast TWT.

In the first example, a Broadcast TWT is used to set a TWT during the communications 701 and 702 illustrated in FIG. 7. The present disclosure is not limited to that described above, and in a case where a TWT is to be set between the communication apparatuses 101 and 102, the communication apparatus 102 may request an Individual TWT, and the communication apparatus 101 may return a response, thereby setting the TWT. Similarly, the communication apparatus 103 may request an Individual TWT, and the communication apparatus 102 may return a response, thereby setting the TWT. At this time, the communication apparatus 102 may determine whether to accept, alternate, dictate, or reject the request from the communication apparatus 103 based on the TWT SP determined with the communication apparatus 101. In a case where the TWT setup is to be presented using the Dictate, the communication apparatus 102 may present a value (e.g., the value specified in step S405 or S406 in FIG. 4) calculated based on the period determined between the communication apparatuses 101 and 102.

As described above, in a situation where the STA and the GO may perform simultaneous operation, it is possible to properly set one of the TWT SPs based on the other TWT SP. This makes it possible to properly perform communications that use different communication methods and may be performed simultaneously.

### Second Example

In the present example, the communication apparatus 101 operates as a STA, the communication apparatus 102 operates as an AP and a GO, and the communication apparatus 103 operates as a CL.

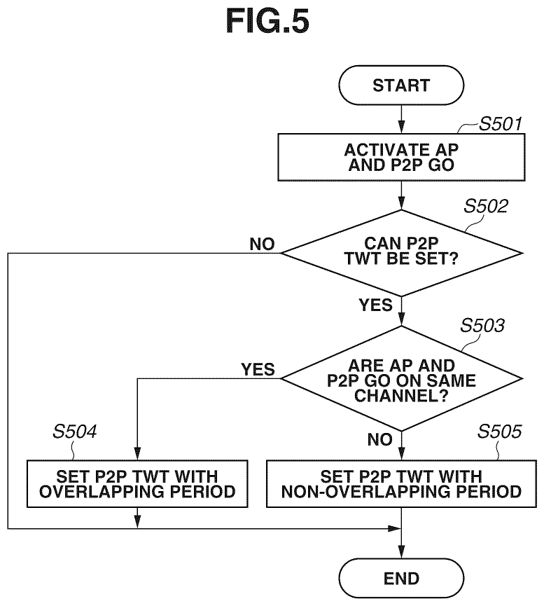

FIG. 5 is a flowchart illustrating an example of a flow of a process performed by the control unit 202 executing a program stored in the storage unit 201 of the communication apparatus 102.

Specifically, FIG. 5 illustrates an example of a process in which a TWT is set through simultaneous operation between an AP and a WFD GO. More specifically, FIG. 5 illustrates an example of a process of setting a TWT after the communication apparatus 102 establishes an infrastructure connection with the communication apparatus 101 and a WFD connection with the communication apparatus 103. The process is started when the communication apparatus 102 establishes an infrastructure connection with the communication apparatus 101 and a WFD connection with the communication apparatus 103. The process may be started in a case where the communication apparatus 102 establishes only one of the connections. The process may be repeated after the simultaneous operation process.

In step S501, the communication apparatus 102 is activated as an AP and connects to the communication apparatus 101 operating as a STA. In step S501, the communication apparatus 102 is activated as a WFD (P2P) GO and connects to the communication apparatus 103 operating as a CL.

In step S502, the communication apparatus 102 checks whether a TWT can be set or activated or executed as a GO. Since the checking method in step S502 is described above in the first example (e.g., refer to step S410 and the like), the description will be omitted.

In a case where a TWT can be set on the network created by the communication apparatus 102 as a GO (YES in step S502), in step S503, the communication apparatus 102 checks whether a channel on which the communication apparatus 102 operates as an AP and a channel on which the communication apparatus 102 operates as a GO are the same.

In a case where the channels are the same (YES in step S503), in step S504, the communication apparatus 102 sets a TWT SP also on the network created by the communication apparatus 102 as a GO so that the TWT SP fully overlaps the TWT SP received from the communication apparatus 101. This makes it possible for the communication apparatus 102 to align the TWT SPs as an AP and as a GO, and by setting the period outside the TWT SPs to a state in which transmission and reception can be performed (e.g., a period during which transmission and reception can be performed), power savings are achieved. The TWT SPs may be set to overlap partially. This makes it easier to perform frame exchange that is inevitably required during the TWT SPs. Alternatively, the communication apparatus 102 may set non-overlapping, continuous periods as the TWT SPs as an AP and as a GO. A preparatory period during which a frame can be transmitted or received is allocated before and after the TWT SP, which makes it possible to reduce the overhead. Reducing overhead enables power-saving operation.

On the other hand, in a case where the channels are different (NO in step S503), in step S505, the communication apparatus 102 sets a TWT SP on the network created by the communication apparatus 102 as a GO so that the TWT SP does not (e.g., even partially) overlap the TWT SP received from the communication apparatus 101. In a case where the communication apparatus 102 can operate on only one channel at a time, if the TWT SPs for the communication apparatuses 101 and 103 overlap, the communication apparatus 102 may not be able to perform one of the communications. Thus, the TWT SPs are set in step S505 as described above, thereby enabling the communication apparatuses 101 and 103 to continue communication. This makes it possible to improve the reliability of communication.

In a case where the communication apparatus 102 cannot set a TWT as a GO (NO in step S502), the communication apparatus 102 only sets a TWT as an AP.

After receiving a request with an appended TWT Element from the STA or the CL while establishing a connection, the communication apparatus 102 sets a TWT in response to the request. In a case where the request from the STA or the CL differs from the value determined in step S504 or S505, the communication apparatus 102 changes the TWT SP to the value determined in step S504 or S505 by designating an Alternate TWT or a Dictate TWT. Alternatively, the communication apparatus 102 may set a Broadcast TWT in a Beacon frame.

FIG. 9 is a diagram illustrating an example of a processing sequence of communication apparatuses for setting a TWT according to the second example. FIG. 9 illustrates an example of a case where a TWT is set between the communication apparatuses 102 and 103 first and then a TWT is set between the communication apparatuses 102 and 101. For example, the case illustrated in FIG. 9 may apply to a case where the communication apparatuses 102 and 103 are connected first and then the communication apparatuses 102 and 101 are connected.

The communication apparatus 102 appends or includes a TWT Element to a Beacon frame, a Probe Response frame, an Association Response frame, or the like that is to be transmitted by the communication apparatus 102 as a GO. Then, the communication apparatus 102 transmits the resulting frame (901: TWT setup). This makes it possible for the communication apparatus 102 to notify the TWT SP to the CL connected to the communication apparatus 102.

Next, the communication apparatus 102 similarly appends or includes a TWT Element to a Beacon frame, a Probe Response frame, an Association Response frame, or the like that is to be transmitted by the communication apparatus 102 as an AP. Then, the communication apparatus 102 transmits the resulting frame (902: TWT setup). This makes it possible for the communication apparatus 102 to notify the TWT SP to the STA connected to the communication apparatus 102.

In the second example, a Broadcast TWT is used to set a TWT during the communications 901 and 902 illustrated in FIG. 9. The present disclosure is not limited to that described above, and in a case where a TWT is to be set between the communication apparatuses 101 and 102, the communication apparatus 102 may request an Individual TWT, and the communication apparatus 101 may return a response, thereby setting the TWT. Similarly, the communication apparatus 103 may request an Individual TWT, and the communication apparatus 102 may return a response, thereby setting the TWT. At this time, the communication apparatus 102 may determine whether to accept, alternate, dictate, or reject the request from the communication apparatus 101 based on the TWT SP determined with the communication apparatus 103. In a case where the TWT setup is to be presented using the Dictate, the communication apparatus 102 may present a value (e.g., the value specified in step S504 or S505) calculated based on the period determined between the communication apparatuses 103 and 102.

As described above, in a situation where the AP and the GO may perform simultaneous operation, it is possible to properly set one of the TWT SPs based on the other TWT SP. This makes it possible to properly perform communications that use different communication methods and may be performed simultaneously.

### Third Example

In the present example, the communication apparatus 101 operates as an AP, the communication apparatus 102 operates as a STA and a CL, and the communication apparatus 103 operates as a GO.

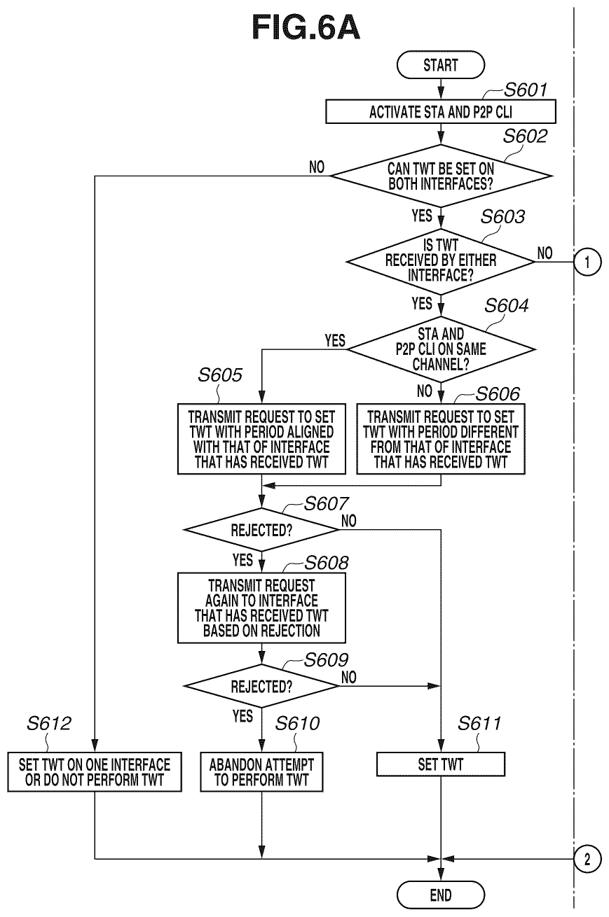

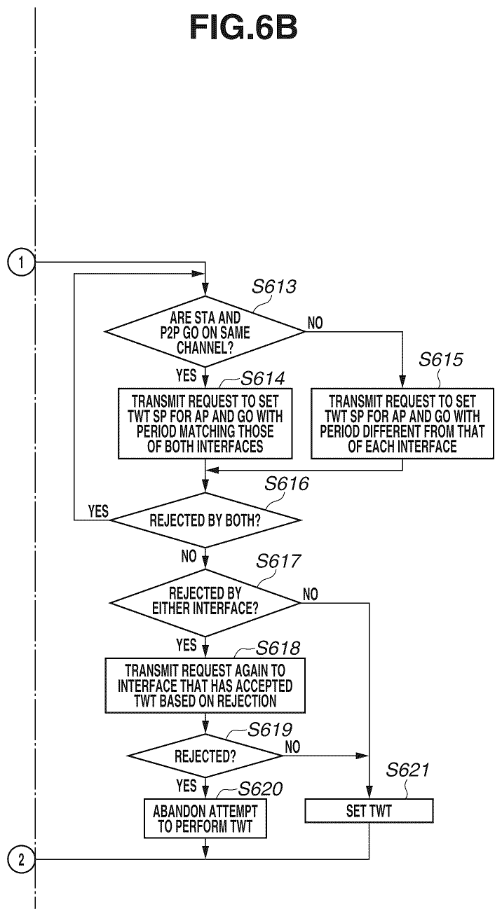

FIGS. 6A and 6B show a flowchart illustrating an example of a flow of a process performed by the control unit 202 executing a program stored in the storage unit 201 of the communication apparatus 102.

Specifically, FIGS. 6A and 6B illustrate an example of a process in which a TWT is set through simultaneous operation between a STA and a WFD CL. More specifically, FIGS. 6A and 6B illustrate an example of a process of setting a TWT after the communication apparatus 102 establishes an infrastructure connection with the communication apparatus 101 and a WFD connection with the communication apparatus 103. The process is started when the communication apparatus 102 establishes an infrastructure connection with the communication apparatus 101 and a WFD connection with the communication apparatus 103. The process may be started in a case where the communication apparatus 102 establishes only one of the connections. The process may be repeated after the simultaneous operation process.

In step S601, the communication apparatus 102 is activated as a STA and connects to the communication apparatus 101 operating as an AP. In step S601, the communication apparatus 102 is activated as a WFD (P2P) CL and connects to the communication apparatus 103 operating as a GO.

In step S602, the communication apparatus 102 checks whether a TWT can be set or activated or executed both as a STA and a CL. Hereinafter, each of the STA and the CL may also be referred to as an interface (IF). Since the checking method in step S602 is described above in the first example (e.g., refer to step S410 and the like), the description will be omitted.

In a case where a TWT can be set on only one of the IFs or cannot be set on either IF (NO in step S602), in step S612, the communication apparatus 102 sets a TWT on only one of the IFs or does not set a TWT.

On the other hand, in a case where a TWT can be set on both IFs (YES in step S602), in step S603, the communication apparatus 102 checks whether a TWT is set on either IF. This checking is performed because a TWT has been set using a Broadcast TWT by, for example, the AP and/or the GO. In a case where a TWT is set on either IF (YES in step S603), the processing proceeds to step S604, and in a case where no TWT is set on either IF (NO in step S603), the processing proceeds to step S613.

In a case where a TWT is set on either IF (YES in step S603), in step S604, the communication apparatus 102 checks whether the STA and the CL operate on the same channel.

In a case where the STA and the CL operate on the same channel (YES in step S604), in step S605, the communication apparatus 102 transmits a TWT setup request from the IF on which no TWT is set so that the TWT SPs are aligned between the IFs. At this time, the communication apparatus 102 sets a value of either 1 (Suggest TWT) or 2 (Demand TWT) in the TWT Setup Command sub-field 1232.

On the other hand, in a case where the STA and the CL operate on different channels (NO in step S604), in step S606, the communication apparatus 102 transmits a TWT setup request from the IF on which no TWT is set so that the TWT SPs differ between the IFs.

In step S607, the communication apparatus 102 receives a response to the request from the AP or the GO and checks whether the TWT setup is rejected.

In a case where the value stored in the TWT Setup Command sub-field 1232 in the response frame is 4 and the request is accepted (NO in step S607), in step S611, TWT SPs are set on both IFs.

In a case where the request is rejected or not accepted (YES in step S607), the communication apparatus 102 first checks a value with which a TWT can be set on the network that the requesting IF has joined, and then sets a TWT. At this time, if the communication apparatus 102 cannot set a TWT, the processing may proceed to step S610. In step S608, after a TWT is set, the communication apparatus 102 requests or demands re-setting of the TWT SP to correspond to the operation from the IF that has not transmitted the request in step S605 or S606. In step S609, after transmitting the request or demand from the IF that has not transmitted the request, the communication apparatus 102 checks a response from the AP or the GO. In a case where the request or demand is rejected or not accepted also in this step (YES in step S609), in step S610, the communication apparatus 102 abandons the attempt to perform TWT. Alternatively, the communication apparatus 102 may abandon the attempt to perform simultaneous operation, disassociate from the network that the communication apparatus 102 has joined as one of the IFs, and operate only as the other IF. On the other hand, in a case where the request or demand is accepted (NO in step S609), in step S611, a TWT SP is set on both IFs.

In step S607, in a case where a value of 5 or 6 is set in the TWT Setup Command sub-field 1232 in the response frame and an alternate TWT is requested, the processing may proceed to step S608. Alternatively, in this case, the processing may return to step S604.

In step S607, in a case where a value of 7 is set in the TWT Setup Command sub-field 1232 in the response frame and the request is rejected, the processing may proceed to step S610.

In a case where a TWT is not set on both networks that the IFs have joined (NO in step S603) or a case where the communication apparatus 102 is aware that it is operating as a CL and a STA but is not connected to either network, the processing proceeds to step S613.

In step S613, the communication apparatus 102 checks whether the STA and the CL operate on the same channel.

In a case where the STA and the CL operate on the same channel (YES in step S613), in step S614, the communication apparatus 102 transmits, to the connected AP and the connected GO, a request to set a TWT SP so that each TWT SP is the exact same period, a partially overlapping period, or a continuous period.

On the other hand, in a case where the STA and the CL operate on different channels (NO in step S613), in step S615, the communication apparatus 102 transmits, to the connected AP and the connected GO, a request to set a TWT SP so that the TWT SP is a different period.

In step S616, the communication apparatus 102 receives responses to the requests from the AP and the GO and checks whether the requests are rejected by both IFs. In a case where the requests are rejected or not accepted by both (YES in step S616), the processing returns to step S613. On the other hand, in a case where not both requests are rejected or not accepted (NO in step S616), in step S617, the communication apparatus 102 checks whether only one of the IFs has rejected the request. In a case where the requests are accepted by both IFs (NO in step S617), in step S621, a TWT SP is set on both IFs. On the other hand, in a case where one of the IFs has not accepted the request (YES in step S617), the communication apparatus 102 sets a TWT that can be set on the IF that has rejected the request. At this time, in a case where the communication apparatus 102 cannot set a TWT on the IF that has rejected the request, the processing may proceed to step S620. In step S618, after setting a TWT, the communication apparatus 102 requests or demands re-setting of a TWT SP on the other IF based on the TWT SP that is successfully set on the IF that has rejected the request. In step S619, after transmitting the request or demand, the communication apparatus 102 checks a response from the AP or the GO. In a case where the request or demand is also rejected or not accepted (YES in step S619), in step S620, the communication apparatus 102 abandons the attempt to perform TWT. Alternatively, the communication apparatus 102 may abandon the attempt to perform simultaneous operation, disassociate from the network that the communication apparatus 102 has joined as one of the IFs, and operate only as the other IF. On the other hand, in a case where the request or demand is accepted (NO in step S619), in step S621, a TWT SP is set on both IFs.

In step S603, in a case where a TWT is set on both IFs, the processing may proceed to step S604 or to step S613. In step S604, the communication apparatus 102 selects one of the IFs and transmits a TWT setup request only as the selected IF. On the other hand, in step S613, the communication apparatus 102 transmits a TWT setup request as both IFs.

At this time, in a case where re-setting is necessary on either IF, the communication apparatus 102 transmits a request to check whether re-setting is possible.

FIG. 10 is a diagram illustrating processing sequences of communication apparatuses for setting a TWT according to the third example. FIG. 10 illustrates an example of a case where a TWT is set between the communication apparatuses 102 and 103 first and then a TWT is set between the communication apparatuses 102 and 101.

For example, the case illustrated in FIG. 10 may apply to a case where the communication apparatuses 102 and 103 are connected first and then the communication apparatuses 102 and 101 are connected.

The communication apparatus 103 appends or includes a TWT Element to a Beacon frame, a Probe Response frame, an Association Response frame, or the like that is to be transmitted by the communication apparatus 103 as a GO. Then, the communication apparatus 103 transmits the resulting frame (1001: TWT setup). This makes it possible for the communication apparatus 103 to notify the TWT SP to the STA connected to the communication apparatus 103.

Next, the communication apparatus 102 calculates a TWT SP to be set between the communication apparatuses 102 and 101 based on the TWT SP determined between the communication apparatuses 102 and 103 and issues a request to set the calculated TWT SP to the communication apparatus 101 (1002: TWT suggest).

The communication apparatus 101 does not accept the request from the communication apparatus 102 and proposes another TWT SP (1003: TWT dictate).

The communication apparatus 102 accepts the proposal from the communication apparatus 101. Furthermore, the communication apparatus 102 determines that it is necessary to re-set the TWT SP determined between the communication apparatuses 102 and 103 based on the TWT SP determined between the communication apparatuses 102 and 101.

The communication apparatus 102 issues a request to re-set the TWT SP to the communication apparatus 103 (1004: TWT request). The communication 1004 may be realized using, for example, a Channel Usage Request frame.

The communication apparatus 103 receives the request from the communication apparatus 102 and accepts the request (1005: TWT accept).

As described above, in a situation where the STA and the CL may perform simultaneous operation, it is possible to properly set one of the TWT SPs based on the other TWT SP. This makes it possible to properly perform communications that use different communication methods and may be performed simultaneously.

### Other Examples

The above-described TWT SP setting is applicable to a case where a communication apparatus performs infrastructure communication with one or more other communication apparatuses and WFD communication with one or more other communication apparatuses, including the first to third examples.

### Other Embodiments

The foregoing embodiments (e.g., the first and second examples) describe examples in which a TWT on the WFD communication side is set or re-set based on a TWT setup on the infrastructure communication side, but the present disclosure is not limited to the examples. According to another embodiment, a TWT on the infrastructure communication side may be set or re-set based on a TWT setup on the WFD communication side.

An example of a process according to the other embodiment will be described with reference to FIG. 4, focusing mainly on the differences from the first example.

In a step corresponding to step S402, in a case where the communication apparatus 102 sets a TWT as a GO first, the processing proceeds to step S403, and in a case where the communication apparatus 102 does not set a TWT as a GO first, the processing proceeds to step S410.

In a case where the communication apparatus 102 can set a TWT as a GO (YES in step S403), the communication apparatus 102 sets a TWT as a GO, and the processing proceeds to step S404.

In a case where a channel on which the communication apparatus 102 operates as a STA and a channel on which the communication apparatus 102 operates as a GO are the same (YES in step S404), the communication apparatus 102 issues a request to set a TWT SP as a STA as follows. Specifically, the communication apparatus 102 issues a request to set a TWT SP as a STA to the communication apparatus 101 so that the TWT SP fully or partially overlaps or is continuous with the TWT SP set as a GO. Then, unless the request is rejected, in a step corresponding to step S405, the communication apparatus 102 sets a TWT SP as a STA as requested.

On the other hand, in a case where the channels are different (NO in step S404), the communication apparatus 102 issues a request to set a TWT SP as a STA to the communication apparatus 101 so that the TWT SP does not (e.g., even partially) overlap the TWT SP set as a GO. Then, unless the request is rejected, in a step corresponding to step S406, the communication apparatus 102 sets a TWT SP as a STA as requested.

In a case where a TWT can be set as a GO (YES in step S410), the communication apparatus 102 sets a TWT as a GO, and the processing proceeds to step S414.

In a case where a channel on which the communication apparatus 102 operates as a STA and a channel on which the communication apparatus 102 operates as a GO are the same (YES in step S414), the communication apparatus 102 issues a request to set a TWT SP as a STA as follows. Specifically, the communication apparatus 102 issues a request to set a TWT SP as a STA to the communication apparatus 101 so that the TWT SP fully or partially overlaps or is continuous with the TWT SP set as a GO. Then, unless the request is rejected, in a step corresponding to step S415, the communication apparatus 102 sets a TWT SP as a STA as requested.

On the other hand, in a case where the channels are different (NO in step S414), the communication apparatus 102 issues a request to set a TWT SP as a STA to the communication apparatus 101 so that the TWT SP does not (e.g., even partially) overlap the TWT SP set as a GO. Then, unless the request is rejected, in a step corresponding to step S416, the communication apparatus 102 sets a TWT SP as a STA as requested.

Next, an example of a process according to the other embodiment will be described with reference to FIG. 5, focusing mainly on the differences from the second example.

In a case where the communication apparatus 102 can set a TWT as a GO (YES in step S502), the communication apparatus 102 sets a TWT as a GO, and the processing proceeds to step S503.

In a case where a channel on which the communication apparatus 102 operates as a STA and a channel on which the communication apparatus 102 operates as a GO are the same (YES in step S503), in a step corresponding to step S504, the communication apparatus 102 sets a TWT SP as an AP as follows. Specifically, the communication apparatus 102 sets a TWT SP as an AP so that the TWT SP fully or partially overlaps or is continuous with the TWT SP set as a GO.

On the other hand, in a case where the channels are different (NO in step S503), in a step corresponding to step S505, the communication apparatus 102 sets a TWT SP as an AP so that the TWT SP does not (e.g., even partially) overlap the TWT SP set as a GO.

A storage medium storing a program code of software configured to realize the above-described function may be supplied to a system or an apparatus, and a computer (a CPU or an MPU) of the system or the apparatus may read and execute the program code stored in the storage medium. In this case, the program code read from the storage medium realizes the above-described function of the embodiments, and the storage medium storing the program code constitutes the apparatus.

Examples of a storage medium used to supply the program code include a flexible disk, a hard disk, an optical disk, a magneto-optical disk, a CD-ROM, a CD-R, a magnetic tape, a non-volatile memory card, a ROM, a DVD, and the like.

The above-described functions may be realized not only by a computer by executing the read program code but also by an OS running on a computer by performing some or all of an actual process based on an instruction of the program code.

Furthermore, the program code read from the storage medium is written to a memory of a function extension board inserted in the computer or a memory of a function extension unit connected to the computer.

Then, a CPU of the function extension board or the function extension unit may perform some or all of the actual process based on the instruction of the program code to realize the above-described function.

The present disclosure can also be implemented by supplying a program that realizes one or more functions of the above-described embodiments to a system or an apparatus via a network or a storage medium, and causing one or more processors of a computer in the system or apparatus to read and execute the program. Furthermore, the present disclosure can also be implemented by a circuit (e.g., an ASIC) that realizes one or more functions.

Some of the processes described above with reference to the flowcharts in the present disclosure may be realized by hardware. For example, a predetermined compiler may be used to automatically generate a dedicated circuit on a field-programmable gate array (FPGA) from a program for realizing each step. A gate array circuit may be formed similarly to an FPGA to realize some of the processes as hardware.

The terms used in the above-described embodiments, such as “functional unit”, “message”, “parameter”, and “field”, may be changed to other terms.

The orders in the processing procedures, sequences, flowcharts, and the like according to the above-described embodiments are not restricted to the specific orders presented, and may be changed as long as consistency is ensured, or an additional step may be added.

According to the above-described embodiments, one of the TWT SPs is set to be properly based on the other TWT SP, thereby making it possible to realize simultaneous operation with improved power efficiency. It also becomes possible to perform communication (e.g., infrastructure communication and WFD communication) using a plurality of communication methods without interference between the communications. This makes it possible to properly perform communications that use different communication methods and that may be performed simultaneously.

An aspect of the present disclosure makes it possible to properly perform communications that use different communication methods and that may be performed simultaneously.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-213382, filed Dec. 6, 2024, which is hereby incorporated by reference herein in its entirety.

What is claimed is:

1. A communication apparatus comprising:
at least one memory storing a set of instructions; and
at least one processor that, upon execution of the stored instructions, is configured to operate as:
a reception unit configured to receive information about a first wake period for communicating with a first partner communication apparatus by using a first communication method from the first partner communication apparatus; and
a determination unit configured to determine a second wake period for communicating with a second partner communication apparatus by using a second communication method based on the first wake period.

2. The communication apparatus according to claim 1, wherein the first communication method is used on a network created by the first partner communication apparatus, and the second communication method is used on a network created by the communication apparatus.

3. The communication apparatus according to claim 2, wherein the instructions further cause the communication apparatus to transmit information requesting the second wake period to the second partner communication apparatus by using the second communication method.

4. The communication apparatus according to claim 2, wherein the first partner communication apparatus is an access point, and the communication apparatus and the second partner communication apparatus are stations.

5. The communication apparatus according to claim 1, wherein the first communication method is used on a first network created by the communication apparatus, and the second communication method is used on a second network created by the communication apparatus.

6. The communication apparatus according to claim 5, wherein the communication apparatus is an access point, and the first partner communication apparatus and the second partner communication apparatus are stations.

7. The communication apparatus according to claim 1, wherein the first communication method is used on a network created by the first partner communication apparatus, and the second communication method is used on a network created by the second partner communication apparatus.

8. The communication apparatus according to claim 7, wherein the instructions further cause the communication apparatus to transmit information requesting the second wake period to the second partner communication apparatus by using the second communication method.

9. The communication apparatus according to claim 7, wherein the first partner communication apparatus is an access point, and the communication apparatus and the second partner communication apparatus are stations.

10. The communication apparatus according to claim 7, wherein the second partner communication apparatus is an access point, and the communication apparatus and the first partner communication apparatus are stations.

11. The communication apparatus according to claim 1, wherein in a case where a channel used for communication with the first partner communication apparatus by using the first communication method and a channel used for communication with the second partner communication apparatus by using the second communication method are the same, the first wake period and the second wake period at least partially overlap.

12. The communication apparatus according to claim 1, wherein in a case where a channel used for communication with the first partner communication apparatus by using the first communication method and a channel used for communication with the second partner communication apparatus by using the second communication method are the same, the first wake period and the second wake period are continuous.

13. The communication apparatus according to claim 1, wherein in a case where a channel used for communication with the first partner communication apparatus by using the first communication method and a channel used for communication with the second partner communication apparatus by using the second communication method are different, the first wake period and the second wake period do not overlap.

14. A method for controlling a communication apparatus, the method comprising:
receiving information about a first wake period for communicating with a first partner communication apparatus by using a first communication method from the first partner communication apparatus; and
determining a second wake period for communicating with a second partner communication apparatus by using a second communication method based on the first wake period.

15. A non-transitory computer-readable storage medium storing instructions that, when executed by a computer, cause the computer to perform a method for controlling a communication apparatus, the method comprising:
receiving information about a first wake period for communicating with a first partner communication apparatus by using a first communication method from the first partner communication apparatus; and
determining a second wake period for communicating with a second partner communication apparatus by using a second communication method based on the first wake period.
